(19) United States
(12) Patent Application Publication
(10) Pub. No.: US 2019/0162928 A1
(43) Pub. Date: May 30, 2019

(54) IMAGE PICKUP DEVICE

(71) Applicant: Panasonic Intellectual Property Management Co., Ltd., Osaka (JP)

(72) Inventors: HARUKI OTA, Kanagawa (JP); KAZUHIRO NAGAMATSU, Kanagawa (JP); TATSUHIKO INAGAKI, Kanagawa (JP); TOMIO SHIMIZU, Kanagawa (JP)

(21) Appl. No.: 16/309,946

(22) PCT Filed: Apr. 24, 2017
(86) PCT No.: PCT/JP2017/016130

§ 371 Date: Dec. 14, 2018

(30) Foreign Application Priority Data
Sep. 1, 2016 (JP) 2016-171092

(51) Int. Cl. G02B 7/08; G03B 15/00; H04N 5/232; H04N 5/225

(52) U.S. Cl. CPC G02B 7/08; G03B 15/00; H04N 5/2258; H04N 5/23238; H04N 5/23203

(57) ABSTRACT

An imaging device includes a multifocal lens switchable between a plurality of types of angular fields, an angular field controller, an image sensor, a signal processor, and an image processor. The angular field controller receives angular field information indicating an angular field used for capturing an image, and controls the angular field of the multifocal lens based on the angular field information. The image sensor converts light passing through the multifocal lens into an electrical signal. The signal processor converts the electrical signal into an image signal. The image processor receives the angular field information and the image signal, performs predetermined image processing on the image signal based on a parameter which is predetermined in accordance with the angular field information, and externally outputs the image data obtained by the image processing.

### TECHNICAL FIELD

The present disclosure relates to an imaging device.

### BACKGROUND ART

Recently, vehicles are equipped with an imaging device (hereinafter, referred to as a camera) for capturing an image of the surround of the vehicle.

Generally, a method in which a zoom lens is used (for example, see Patent Literature (PTL) 1) is known as a method for obtaining images with different angular fields (angles of views) by using a camera.

### CITATION LIST

### Patent Literature

PTL 1: Japanese Unexamined Patent Publication No. 2007-43248

### SUMMARY OF THE INVENTION

The present disclosure provides an imaging device capable of ensuring high image quality while reducing the mounting space and the cost.

An imaging device according to the present disclosure includes a multifocal lens switchable between a plurality of types of angular fields, an angular field controller, an image sensor, a signal processor, and an image processor. The angular field controller receives angular field information indicating an angular field used for capturing an image, and controls the angular field of the multifocal lens based on the angular field information. The image sensor converts light passing through the multifocal lens into an electrical signal. The signal processor converts the electrical signal into an image signal. The image processor receives the angular field information and the image signal, performs predetermined image processing on the image signal based on a parameter which is predetermined in accordance with the angular field information, and externally outputs the image data obtained by the image processing.

According to the present disclosure, it is possible to ensure high image quality while reducing the mounting space and the cost.

### BRIEF DESCRIPTION OF DRAWINGS

FIG. 1 illustrates a configuration example of an imaging device according to an embodiment of the present disclosure.

FIG. 2A illustrates a state where the angular field is switched to a wide angle in a lens unit of the imaging device illustrated in FIG. 1.

FIG. 2B illustrates a state where the angular field is switched to a narrow angle in the lens unit of the imaging device illustrated in FIG. 1.

FIG. 3A is a perspective view showing an appearance of the front side of an imaging module which is an example of the imaging device illustrated in FIG. 1.

FIG. 3B is a perspective view showing an appearance of the back side of the imaging module illustrated in FIG. 3A.

FIG. 4A is a perspective view showing an appearance of the front side of a housing which accommodates the imaging module illustrated in FIG. 3A.

FIG. 4B is a perspective view showing an appearance of the back side of the housing illustrated in FIG. 4A.

### DESCRIPTION OF EMBODIMENTS

Prior to description of an embodiment of the present disclosure, problems in conventional imaging devices will be briefly described. A camera including a zoom lens is not suited for mounting to the vehicle due to an increased number of lenses or increased sizes of the lenses.

A technique to obtain images with different angular fields by using cameras mounted to a vehicle includes, for example, the following two techniques (hereinafter, referred to as a first technique and a second technique).

According to the first technique, a wide angle camera and a narrow angle camera are mounted to a vehicle to obtain a wide angle image using the wide angle camera and the narrow angle image using the narrow angle camera.

In the second technique, one wide angle camera is mounted to a vehicle, and a narrow angle image is obtained by clipping a predetermined range from the wide angle image captured by the wide angle camera and enlarging the clipped range.

However, in the first technique, space for mounting two cameras is required.

Moreover, in the second technique, the narrow angle image obtained by the enlarging has a decreased resolution. In particular, when the difference in angular field between the wide angle image and the narrow angle image is twice or greater, the resolution greatly decreases. In order to ensure the image quality of the narrow angle image, a measure, such as using a high-pixel sensor, is required, which leads to an increased cost.

Therefore, there is a demand for a technique which can ensure high image quality without requiring a plurality of cameras with different angular fields, a high pixel sensor and the like. Note that there is a demand for such a technique not only in the case of mounting a camera to a vehicle, but also in the case of mounting a camera to a limited space.

Hereinafter, an embodiment according to the present disclosure will be described with reference to the drawings.

<Configuration of Imaging Device 100>

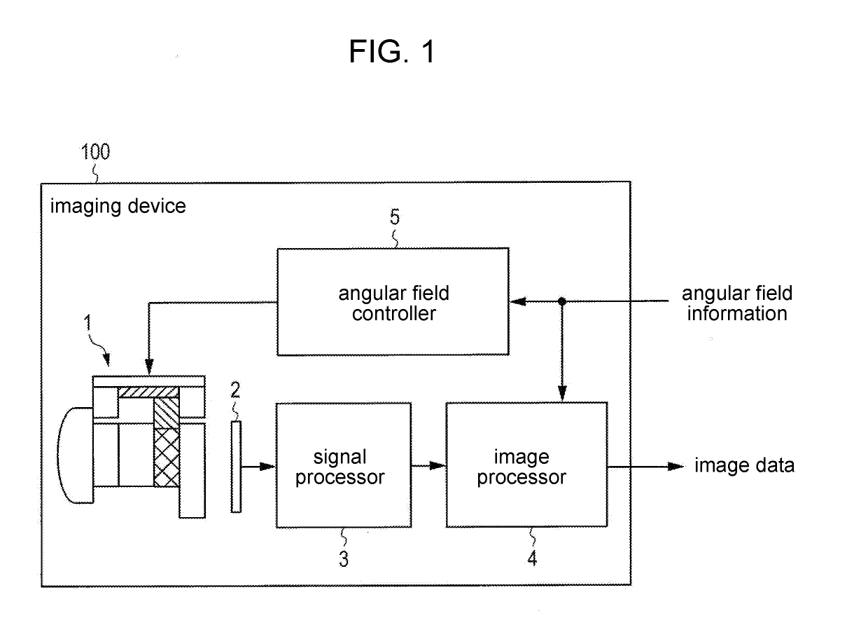

First, a configuration of imaging device 100 according to an embodiment will be described with reference to FIG. 1. FIG. 1 illustrates a configuration example of imaging device 100.

Imaging device 100 is mounted to a vehicle to capture an image of the area surrounding the vehicle. Imaging device 100 includes lens unit 1, image sensor (solid-state imaging element) 2, signal processor 3, image processor 4, and angular field controller 5.

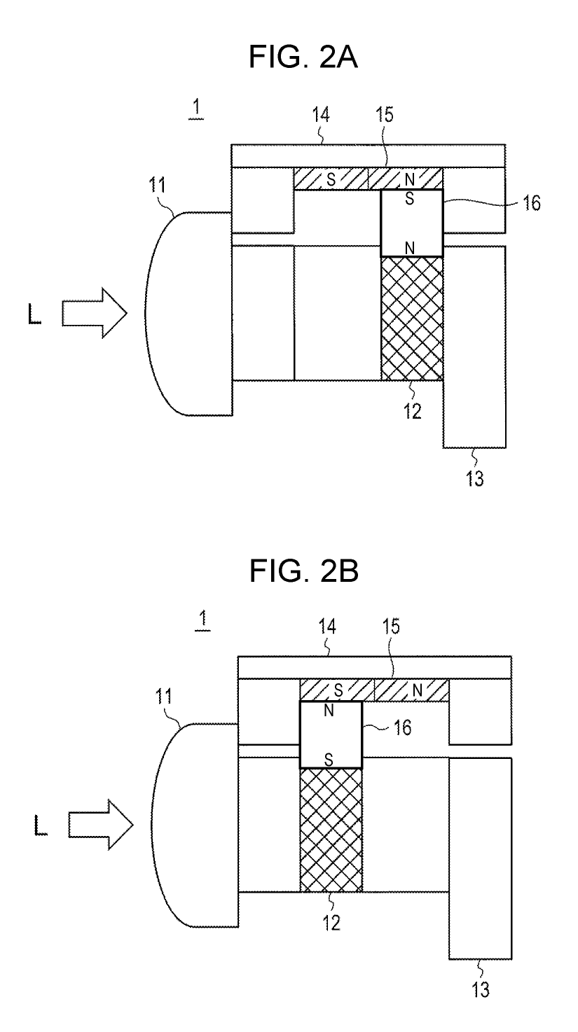

Lens unit 1 includes a multifocal lens which is switchable between a plurality of types of angular fields (angles of views). In the present embodiment, as an example, lens unit 1 includes a bifocal lens which is switchable between two types of angular fields, a wide angle (wide side) and a narrow angle (tele side). The wide angle which is a first angular field is, for example, a horizontal angle of 180°, and the narrow angle which is a second angular field, is, for example, a horizontal angle of 60°. The details of the configuration of lens unit 1 will be described later with reference to FIG. 2A and FIG. 2B.

Image sensor 2 converts light passing through the bifocal lens (first group lens 11, second group lens 12, and third group lens 13 illustrated in FIG. 2A and FIG. 2B) of lens unit 1 into an electrical signal, and outputs the electrical signal to signal processor 3. For example, a charge coupled device (CCD) image sensor or a complementary metal oxide semiconductor (CMOS) image sensor can be used as image sensor 2.

Signal processor 3 receives the electrical signal from image sensor 2, converts the electrical signal to an image signal, and outputs the converted image signal to image processor 4.

Image processor 4 receives the angular field information indicating the angular field used for capturing an image, and selects a parameter used for image processing, based on the angular field information. The image processing includes, for example, clip processing and distortion correcting processing. The clip processing is processing for clipping a predetermined area from the captured image in the image signal. The distortion correcting processing is processing for correcting the distortion of the captured image in the image signal.

Here, the angular field information and the parameters will be described.

The angular field information indicates, for example, a wide angle or a narrow angle. Examples of the output source of the angular field information include a switch (not illustrated). The switch receives an operation made by a user (for example, a driver) for instructing a desired angular field. Upon receiving the user operation, the switch outputs the angular field information indicating the details of the user instruction (wide angle or narrow angle).

Alternatively, the angular field information may be output from an engine control unit or electronic control unit (ECU) which is not illustrated. For example, when the ECU detects that the shift lever is operated into the reverse position, the ECU outputs the angular field information indicating a wide angle.

The angular field information described above is output, as illustrated in FIG. 1, not only to image processor 4, but also to angular field controller 5 to be described later.

As the parameters, a parameter used for image processing performed on the image captured at a wide angle (hereinafter, referred to as a wide angle parameter) and a parameter used for image processing performed on the image captured at a narrow angle (hereinafter, referred to as a narrow angle parameter) are set in advance.

The wide angle parameter and the narrow angle parameter are necessary for executing, for example, clip processing and distortion correcting processing, and are set in accordance with the mounting position of imaging device 100 (such as the height from the ground) or the angel (such as depression angle or elevation angle). Since these parameters are well known, the detailed descriptions thereof will be omitted.

The wide angle parameter and the narrow angle parameter may be stored in image processor 4 itself, or may be read from a storage device (not illustrated) by image processor 4.

The angular field information and the parameters have been described. Image processor 4 is now described again.

Image processor 4 selects the wide angle parameter, when the angular field information indicates a wide angle. In contrast, image processor 4 selects the narrow angle parameter when the angular field information indicates a narrow angle.

Image processor 4 then receives the image signal from signal processor 3, performs image processing using the selected parameter, and outputs the image data obtained by the image processing to an external predetermined device (not illustrated). Examples of the predetermined device mentioned here include a display, an electronic mirror and a storage device which are mounted to a vehicle.

Image processor 4 may determine the output destination of the image data, based on the angular field information. For example, when the angular field information indicates a wide angle, image processor 4 may output the image data to the display, and when the angular field information indicates a narrow angle, image processor 4 may output the image data to the electronic mirror.

Angular field controller 5 receives the angular field information, and controls the angular field of lens unit 1, based on the angular field information. Specifically, depending on whether the angular field information indicates a wide angle or a narrow angle, angular field controller 5 instructs, to actuator 14 (see FIG. 2A and FIG. 2B), the direction in which current is applied to coil 16 (see FIG. 2A and FIG. 2B). The details will be described later with reference to FIG. 2A and FIG. 2B.

The configuration of imaging device 100 has been described above.

Imaging device 100 described above is mounted at a predetermined position inside or outside the vehicle compartment. For example, imaging device 100 is disposed on the ceiling (roof), rear window, trunk, door mirror or front grille of a vehicle to capture an image surrounding the vehicle (such as frontward, sideward, and rearward of the vehicle).

<Configuration of Lens Unit 1>

Next, a configuration of lens unit 1 illustrated in FIG. 1 will be described with reference to FIG. 2A and FIG. 2B. Each of FIG. 2A and FIG. 2B illustrates a configuration example of lens unit 1. FIG. 2A illustrates a state where the angular field is switched to a wide angle in lens unit 1, and FIG. 2B illustrates a state where the angular field is switched to a narrow angle in lens unit 1.

As illustrated in FIG. 2A and FIG. 2B, lens unit 1 includes first group lens 11, second group lens 12, third group lens 13, actuator 14, permanent magnet 15, and coil 16.

Light L passes through first group lens 11, second group lens 12, and third group lens 13 in this order, and forms an image at image sensor 2 (see FIG. 1).

First group lens 11 and third group lens 13 are fixed in place. Each of first group lens 11 and second group lens 12 may include a plurality of lenses. Moreover, third group lens 13 may include a single lens.

In contrast, second group lens 12 is movable between first group lens 11 and third group lens 13 along an optical axis. Specifically, second group lens 12 is movable from the position illustrated in FIG. 2A to the position illustrated in FIG. 2B, and movable from the position illustrated in FIG. 2B to the position illustrated in FIG. 2A.

In the present embodiment, the position of second group lens 12 illustrated in FIG. 2A is referred to as a “wide angle capturing position (first position)”, and the position of second group lens 12 illustrated in FIG. 2B is referred to as a “narrow angle capturing position (second position)”. The wide angle capturing position is a position at which an image can be captured at a wide angle, and the narrow angle capturing position is a position at which an image can be captured at a narrow angle. These positions are predetermined by adjusting an optical axis and adjusting a focus.

Coil 16 is fixed to the top part of second group lens 12. Coil 16 is disposed so as to oppose permanent magnet 15.

Permanent magnet 15 is disposed above coil 16. Permanent magnet 15 has, for example, a north pole (N pole) on the right side in the figures and a south pole (S pole) on the left side in the figures. Permanent magnet 15 is disposed along the direction in which second group lens 12 moves.

Actuator 14 is a linear motor actuator, and causes coil 16 to function as an electromagnet by applying current to coil 16. Here, actuator 14 applies current to coil 16 in the direction instructed by angular field controller 5.

For example, when the angular field information indicates a wide angle, angular field controller 5 instructs a first direction to actuator 14. The first direction is a direction in which current flows where the upper part of coil 16 serves as an S pole and the lower part of coil 16 serves as an N pole.

Upon receiving the instruction, actuator 14 applies current to coil 16 in the first direction. Accordingly, as illustrated in FIG. 2A, the upper part of coil 16 becomes an S pole and the lower part of coil 16 becomes an N pole. When the upper part (S pole) of coil 16 is attracted to the N pole of permanent magnet 15, coil 16 and second group lens 12 move to the wide angle capturing position illustrated in FIG. 2A.

Movement of second group lens 12 to the wide angle capturing position in this manner allows an image to be captured at a wide angle. In this case, as described above, image processor 4 performs, for example, the clip processing and the distortion correcting processing by using the wide angle parameter, and outputs the resultant image data to the display, for example.

In contrast, for example, when the angular field information indicates a wide angle, angular field controller 5 instructs a second direction to actuator 14. The second direction is opposite to the first direction, and is the direction in which current flows where the upper part of coil 16 serves as an N pole, and the lower part of coil 16 serves as an S pole.

Upon receiving the instruction, actuator 14 applies current to coil 16 in the second direction. Accordingly, as illustrated in FIG. 2B, the upper part of coil 16 becomes an N pole and the lower part of coil 16 becomes an S pole. When the upper part (N pole) of coil 16 is attracted to the S pole of permanent magnet 15, coil 16 and second group lens 12 move to the narrow angle capturing position illustrated in FIG. 2B. In this manner, an image can be captured at a narrow angle.

Movement of second group lens 12 to the narrow angle capturing position in this manner allows an image to be captured at a narrow angle. In this case, as described above, image processor 4 performs, for example, the clip processing by using the narrow angle parameter, and outputs the resultant image data to, for example, an electronic mirror.

The configuration of lens unit 1 has been described above.

<Operation and Effect of Imaging Device 100>

As described above, when an image is to be captured at the wide angle, imaging device 100 moves second group lens 12 to the predetermined wide angle capturing position to capture the image, and performs image processing by using the wide angle parameter. Moreover, when an image is to be captured at the narrow angle, imaging device 100 moves second group lens 12 to the predetermined narrow angle capturing position to capture the image, and performs image processing by using the narrow angle parameter.

In other words, since imaging device 100 is capable of performing both wide angle image capturing and narrow angle image capturing, a plurality of imaging devices with different angular fields are not required in the vehicle, which leads to a reduction in mounting space for the imaging device(s).

Moreover, imaging device 100 does not require processing for clipping a predetermined range from an image obtained by wide angle capturing and enlarging the clipped region. Accordingly, it is possible to reduce cost for measure to prevent that the resolution is reduced due to such processing (for example, employing of a high-pixel sensor).

Moreover, imaging device 100 performs image processing by using the wide angle parameter on the image captured at the wide angle, and performs image processing by using the narrow angle parameter on the image captured at the narrow angle. Accordingly, high image quality can be ensured for each image.

<Variation>

The present disclosure is not limited to the above embodiment, but many variations are possible. Each variation will be described below.

For example, the case where imaging device 100 is for mounting to a vehicle has been described in the above embodiment as an example, but the present disclosure is not limited to such an example. For example, imaging device 100 may be disposed at a place other than a vehicle (for example, a place where the mounting space is limited).

Moreover, for example, in the above embodiment, the case where lens unit 1 is switchable between two types of angular fields has been described. However, lens unit 1 may be switchable between three or more types of angular fields.

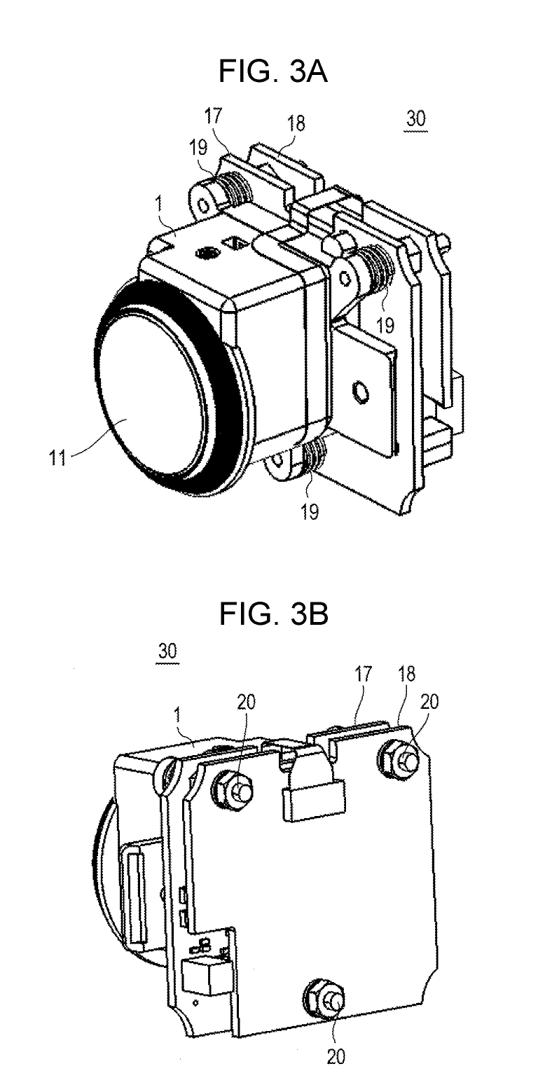

Moreover, for example, the optical axis adjustment and the focus adjustment for setting the wide angle capturing position and the narrow angle capturing position may be performed by screw clamps using springs. This example will be described with reference to FIG. 3A and FIG. 3B. FIG. 3A is a perspective view showing an appearance of the front side of imaging module 30. FIG. 3B is a perspective view showing an appearance of the back side of imaging module 30.

Imaging module 30 includes lens unit 1, sensor (circuit) board 17, and drive (circuit) board 18. For example, image sensor 2, a processor which functions as signal processor 3 (not illustrated), and a processor which functions as image processor 4 (not illustrated) are disposed on sensor board 17. For example, a processor which functions as angular field controller 5 (not illustrated) is disposed on drive board 18. In other words, imaging module 30 is an example of imaging device 100.

As illustrated in FIG. 3A and FIG. 3B, sensor board 17 is positioned on the back side of lens unit 1, and drive board 18 is positioned on the back side of sensor board 17. Moreover, as illustrated in FIG. 3A, springs 19 are disposed between lens unit 1 and sensor board 17.

As illustrated in FIG. 3B, screws 20 are inserted into drive board 18, sensor board 17, and springs 19 from the back side of drive board 18, and screwed to lens unit 1. By using the elastomeric force of springs 19 acting in the direction opposite to the screwing direction, it is possible to perform optical axis adjustment and focus adjustment with higher precision. When each adjustment is completed, adhesive is applied to the entire springs 19 for fixation so that the elastomeric force of springs 19 does not work. Herein, screws 20 are used as an example, but spacers and nuts may be used instead of screws 20.

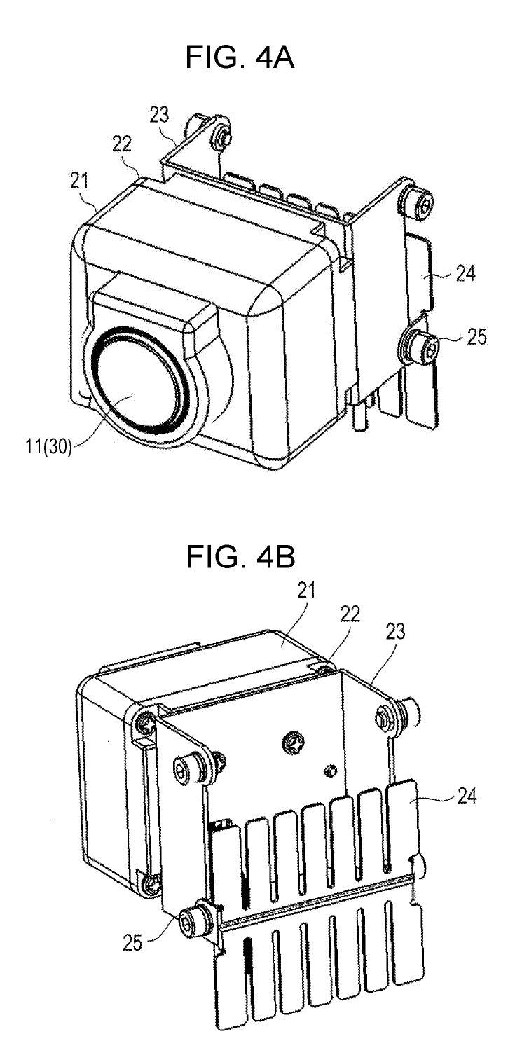

Moreover, for example, imaging module 30 illustrated in FIG. 3A and FIG. 3B may be accommodated in a housing. Such an example is illustrated in FIG. 4A and FIG. 4B. FIG. 4A is a perspective view showing an appearance of the front side of the housing which accommodates imaging module 30. FIG. 4B is a perspective view showing an appearance of the back side of the housing which accommodates imaging module 30.

Imaging module 30 illustrated in FIG. 3A and FIG. 3B are accommodated inside front case 21 and rear case 22 (both are examples of the housing) illustrated in FIG. 4A and FIG. 4B. Waterproof processing is preferably applied by, for example, waterproof silicone or seals (not illustrated) to a region between front case 21 and rear case 22. Moreover or alternatively, a shield component (not illustrated) which surrounds imaging module 30 for protection may be disposed inside front case 21 and rear case 22.

As illustrated in FIG. 4A, first group lens 11 is exposed from the front face of front case 21. Water proof processing is preferably applied to the region around the exposed first group lens 11 by using, for example, an O-ring or water proof silicone (not illustrated).

Moreover, as illustrated in FIG. 4A and FIG. 4B, angle base 23 may be fixed on the back side of rear case 22, and angle member 24 is attached to angle base 23 by screw 25. Angle base 23 is turnably provided with screw 25 serving as a turn axis. Moreover, angle member 24 is fixed to a predetermined position inside or outside the vehicle compartment (such as a ceiling (roof), a rear window, a trunk, a door mirror, or a front grille of the vehicle). With this, it is possible to adjust the elevation angle and depression angle. In other words, angle member 24 is an example of a fixing member for fixing imaging module 30 to the vehicle. That is, imaging device 100 may include a fixing member for fixing imaging device 100 to the vehicle. With this configuration, imaging device 100 can capture an image of the area surrounding the vehicle.

### INDUSTRIAL APPLICABILITY

The imaging device according to the present disclosure is suitable for capturing images at a plurality of angular fields.

### REFERENCE MARKS IN THE DRAWINGS

1 lens unit
2 image sensor
3 signal processor
4 image processor
5 angular field controller
11 first group lens
12 second group lens
13 third group lens
14 actuator
15 permanent magnet
16 coil
17 sensor board
18 drive board
19 spring
20 screw
21 front case
22 rear case
23 angle base
24 angle member
25 screw
30 imaging module
100 imaging device

1. An imaging device comprising:
a multifocal lens switchable between a plurality of types of angular fields;
an angular field controller operable to receive angular field information indicating an angular field used for capturing an image, and to control an angular field of the multifocal lens based on the angular field information;
an image sensor operable to convert light passing through the multifocal lens into an electrical signal;
a signal processor operable to convert the electrical signal into an image signal; and
an image processor operable to receive the angular field information and the image signal, to perform predetermined image processing on the image signal based on a parameter which is predetermined in accordance with the angular field information, and to externally output image data obtained by the predetermined image processing.

2. The imaging device according to claim 1,
wherein the predetermined image processing includes clip processing for clipping a predetermined area from a captured image in the image signal.

3. The imaging device according to claim 1,
wherein the multifocal lens is a bifocal lens switchable between a first angular field and a second angular field which is less than the first angular field,
the bifocal lens includes a first group lens, a second group lens, and a third group lens,
the second group lens is movable between the first group lens and the third group lens,
the imaging device further comprises an actuator operative to move the second group lens to a first position and a second position, the first position being a position at which an image can be captured at the first angular field, the second position being a position at which an image can be captured at the second angular field,
the angular field controller causes the actuator to move the second group lens to the first position, when the angular field information indicates the first angular field, and
the angular field controller causes the actuator to move the second group lens to the second position, when the angular field information indicates the second angular field.

4. The imaging device according to claim 3, further comprising:
a permanent magnet disposed along a direction in which the second group lens moves; and
a coil fixed to the second group lens so as to oppose the permanent magnet,
wherein the actuator moves the second group lens to the first position by applying a current to the coil in a first direction, and
the actuator moves the second group lens to the second position by applying a current to the coil in a second direction opposite to the first direction.

5. The imaging device according to claim 3,
wherein, when the angular field information indicates the first angular field, the image processor performs clip processing for clipping a predetermined area from a captured image in the image signal, and distortion correcting processing for correcting a distortion of the captured image in the image signal, and
when the angular field information indicates the second angular field, the image processor performs the clip processing.

6. The imaging device according to claim 1,
wherein the image processor determines an output destination of the image data, based on the angular field information.

7. The imaging device according to claim 1, further comprising
a fixing member for fixing the imaging device to a vehicle such that the imaging device captures an image of an area surrounding the vehicle.
